(19) United States
(12) Patent Application Publication
(10) Pub. No.: US 2025/0153318 A1
(43) Pub. Date: May 15, 2025

(54) WRENCH FOR OPERATING A VALVE

(71) Applicant: GRDF, Paris (FR)

(72) Inventor: Philippe Frontero, Vallauris (FR)

(21) Appl. No.: 18/835,237

(22) PCT Filed: Feb. 3, 2023
(86) PCT No.: PCT/EP2023/052726

§ 371 Date: Aug. 1, 2024

(30) Foreign Application Priority Data
Feb. 4, 2022 (FR) FR2201001

(51) Int. Cl. B25B 17/02; F16K 31/53; F16K 31/60

(52) U.S. Cl. CPC B25B 17/02; F16K 31/535; F16K 31/60

(57) ABSTRACT

A wrench for operating a valve arranged in an opening comprises: —a hollow operating shaft, which extends from a proximal end to a distal end; —an epicyclic gear train, arranged at the distal end of the operating shaft, and configured to apply a torque, referred to as output torque, to a valve arranged in an opening, as soon as a torque, referred to as input torque, is exerted on the operating shaft, the output torque being greater than the input torque.

### CROSS-REFERENCE TO RELATED APPLICATIONS

This application is a national phase entry under 35 U.S.C. § 371 of International Patent Application PCT/EP2023/052726, filed Feb. 3, 2023, designating the United States of America and published as International Patent Publication WO 2023/148348 A1 on Aug. 10, 2023, which claims the benefit under Article 8 of the Patent Cooperation Treaty of French Patent Application Serial No. FR2201001, filed Feb. 4, 2022.

### TECHNICAL FIELD

The present disclosure relates to the field of fluid distribution networks, and more particularly domestic gas distribution networks. The present disclosure concerns a wrench for operating a valve in a distribution network. In particular, the operating wrench according to the present disclosure is configured to reduce the force exerted by an operator on the valve in order to operate the latter.

### BACKGROUND

The distribution of fluids, and gas, in particular, involves implementing a complex and branched transport and distribution network. This network, which must meet a number of safety and maintenance requirements, is equipped with valves that are suitably positioned to isolate selected sections of the network.

These valves, housed in openings flush with the road surface, can be operated by way of a wrench. The latter may comprise a main shaft at the end of which is an end piece wherein a valve can be engaged. The operating wrench also comprises a handle attached to the main shaft, enabling an operator to exert a force in order to operate the valve in question.

However, there are situations where valve operability is impaired. In particular, valves in gas distribution networks, which are exposed to humidity and ambient dirt, can seize up, and in some cases jam, making them difficult or even impossible to operate using operating wrenches.

Such situations may require the replacement of valves, generating significant operating costs that may be borne by the operators of the network concerned. Alternatively, the handle attached to the main shaft of the operating wrench can be fitted with an extension to increase the torque exerted on the valve. Insofar as the use of an extension does not allow the amplitude of the force exerted on the valve to be calibrated, this solution is not satisfactory.

One of the aims of the present disclosure is therefore to provide a wrench for operating a valve whether or not it is seized.

Another aim of the present disclosure is to provide a more ergonomic operating wrench that reduces the force required from an operator when operating a valve.

Another aim of the present disclosure is to provide a wrench for calibrating the amplitude of the force exerted on a valve.

### BRIEF SUMMARY

The purposes of the present disclosure are, at least in part, achieved by a wrench for operating a valve arranged in an operating, the operating wrench comprising:
a hollow operating shaft, which extends from a proximal end to a distal end;
an epicyclic gear train, arranged at the distal end of the operating shaft, and configured to apply a torque, referred to as output torque, to a valve arranged in an opening, as soon as a torque, referred to as input torque, is exerted on the operating shaft, the output torque being greater than the input torque.

According to one embodiment, the epicyclic gear train is of the parallel type, and comprises a planetary gear, a crown gear and at least one satellite gear, the at least one satellite gear being carried by a satellite carrier pivotably connected with the operating shaft, while the planetary gear is fixedly connected with the operating shaft and is configured to mesh with the at least one satellite gear.

According to one embodiment, the satellite carrier comprises, from the proximal end to the distal end, an upper plate and a lower plate, between which each satellite gear is pivotably mounted about a shaft, called the satellite shaft, and parallel to the operating shaft.

According to one embodiment, the satellite shaft is fixedly connected to both the upper plate and the lower plate.

According to one embodiment, the operating wrench comprises an extension, of non-circular cross section, configured to be mounted in a sliding connection with the lower plate so that rotation of the latter also drives the extension in a rotational movement about the elongation axis of the operating shaft.

In one embodiment, the lower plate comprises a passage, referred to as the central passage, the cross section of which conforms to the cross section of the extension.

According to one embodiment, a passage, referred to as the main passage, is provided in the epicyclic gear train and the operating shaft coaxially with the central passage and the direction of elongation of the operating shaft so as to allow the extension to slide.

According to one embodiment, the operating wrench also comprises embedding means configured to prevent any rotational movement of the crown gear when the operating wrench is engaged to operate a valve.

According to one embodiment, the embedding means comprise an adapter plate that can be embedded against an opening housing a valve, and pins mechanically secured to the crown gear and configured to be embedded in apertures provided in the adapter plate.

In one embodiment, the wrench comprises indexing means configured to indicate the angular stroke of the planetary gear when the operating shaft is rotated.

According to one embodiment, the operating wrench further comprises a handle mechanically secured to the operating shaft and extending in a direction substantially perpendicular to the operating shaft.

### BRIEF DESCRIPTION OF THE DRAWINGS

Other features and advantages of the present disclosure will emerge from the following detailed description of the present disclosure with reference to the appended figures, in which:

FIG. 1 is a schematic depiction of an operating wrench according to the present disclosure;

FIG. 2 is a schematic depiction of an epicyclic gear train that can be used within the scope of the present disclosure; in particular, the epicyclic gear train is shown in a cross-sectional plane parallel to the main faces of the epicyclic gear train;

FIG. 3 is a schematic depiction of the operating shaft shown in FIG. 1, to one end of which the planetary gear is attached;

FIG. 4 is a schematic depiction of a sleeve isolated from the operating shaft and capable of being implemented within the scope of the present disclosure;

FIG. 5 is a schematic depiction of the sleeve of FIG. 4 along a sectional plane perpendicular to the elongation axis of the sleeve and passing through the elongation axis;

FIG. 6 is a depiction along a sectional plane of an epicyclic gear train implemented within the scope of the present disclosure;

FIG. 7 is a schematic depiction of an upper plate of a satellite carrier of the epicyclic gear train shown in FIG. 6;

FIG. 8 is a schematic depiction of a lower plate of a satellite carrier of the epicyclic gear train shown in FIG. 6;

FIG. 9 is a schematic depiction of an adapter plate capable of being implemented within the scope of the present disclosure; and

FIG. 10 is a depiction of a section of an extension capable of being implemented within the scope of the present disclosure.

### DETAILED DESCRIPTION

The present disclosure relates to a wrench for operating a valve housed in an opening. In particular, the operating wrench according to the present disclosure implements an epicyclic gear train designed to reduce the force exerted by an operator when operating a valve by way of the operating wrench.

More particularly, the operating wrench, according to the present disclosure, comprises a hollow operating shaft, which extends from a proximal end to a distal end. The operating wrench also comprises an epicyclic gear train, arranged at the distal end of the operating shaft, and configured to apply a torque, referred to as output torque, to a valve arranged in an opening, as soon as a torque, referred to as input torque, is exerted on the operating shaft, the output torque being greater than the input torque.

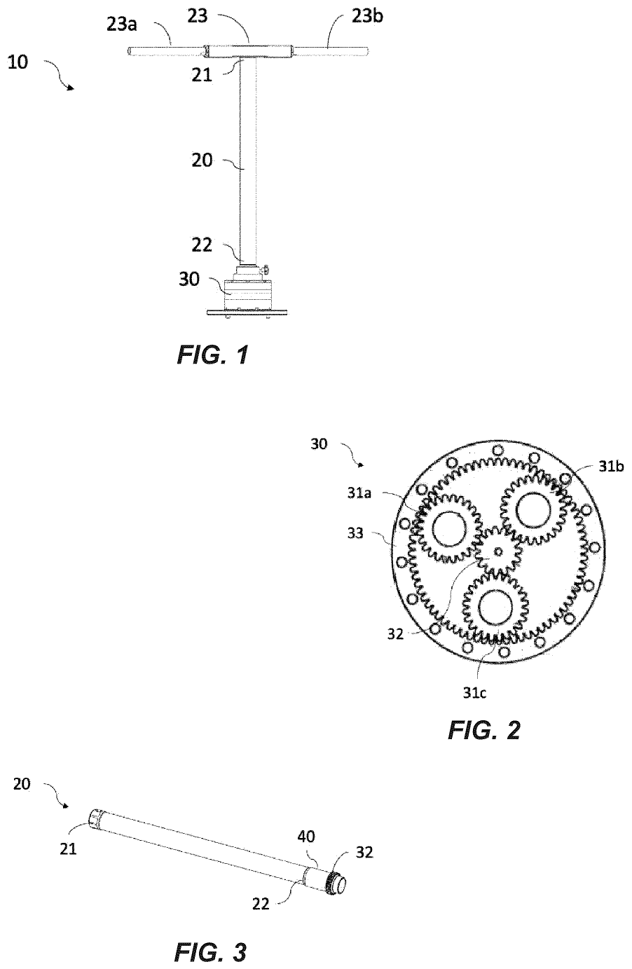

FIG. 1 is a depiction of an operating wrench 10 in accordance with the principles of the present disclosure.

In particular, the operating wrench 10 comprises an operating shaft 20 that extends longitudinally from a proximal end 21 to a distal end 22. More particularly, the operating shaft 20 is hollow, and may comprise, at its proximal end 21, a handle 23 that extends in a direction substantially perpendicular to the operating shaft 20.

As an alternative to the handle, the skilled person may consider a ratchet device for operating the wrench.

Still as an alternative to the handle, the skilled person may also consider a motor for operating the wrench.

In particular, the handle 23 may comprise two grips 23a, 23b arranged symmetrically in relation to the elongation axis of the operating shaft 20.

The operating wrench 10 also comprises an epicyclic gear train 30, arranged at the distal end of the operating shaft, and configured to apply a torque, referred to as output torque, to a valve arranged in an opening, as soon as a torque, referred to as input torque, is exerted on the operating shaft, the output torque being greater than the input torque.

In particular, the epicyclic gear train 30 can be flat or spherical.

The remainder of the disclosure refers only to a planar epicyclic gear train, but the skilled person, on the basis of the present disclosure and his general knowledge, will be able to consider the use of any other type of epicyclic gear train.

The epicyclic gear train 30 according to the present disclosure comprises a plurality of gears. In particular, the epicyclic gear set comprises the following elements:
a planetary gear;
at least one satellite gear; and
a crown gear.

As shown in FIG. 2, the at least one satellite gear 31a, 31b and 31c (three satellite gears in FIG. 2) and the planetary gear 32 are arranged inside the crown gear 33. The satellite gears 31a, 31b and 31c are also configured to mesh with the planetary gear 32 and the crown gear 33. In other words, the satellite gears 31a, 31b and 31c are interposed between the planetary gear 32 and the crown gear. In addition, the axes of rotation of the planetary gear 32 and the crown gear 33 coincide with an elongation axis of the operating shaft.

In operation, the rotation of the planetary gear 32 in one direction of rotation, known as the direct direction, sets the satellite gears 31a, 31b and 31c into motion. In particular, this movement of the satellite gears 31a, 31b and 31c describes a trajectory following an epicycloid. It is understood, without needing to be specified, that in operation the crown gear 33 is held stationary. In other words, the crown gear 33 is in a position where it cannot rotate.

According to the present disclosure, the planetary gear 32 is in fixed connection with the operating shaft 20. In particular, the planetary gear 32 is arranged with the distal end 22 as an extension of the operating shaft 20. In this way, the planetary gear 32 can be rotated by rotating the operating shaft 20 about its elongation axis.

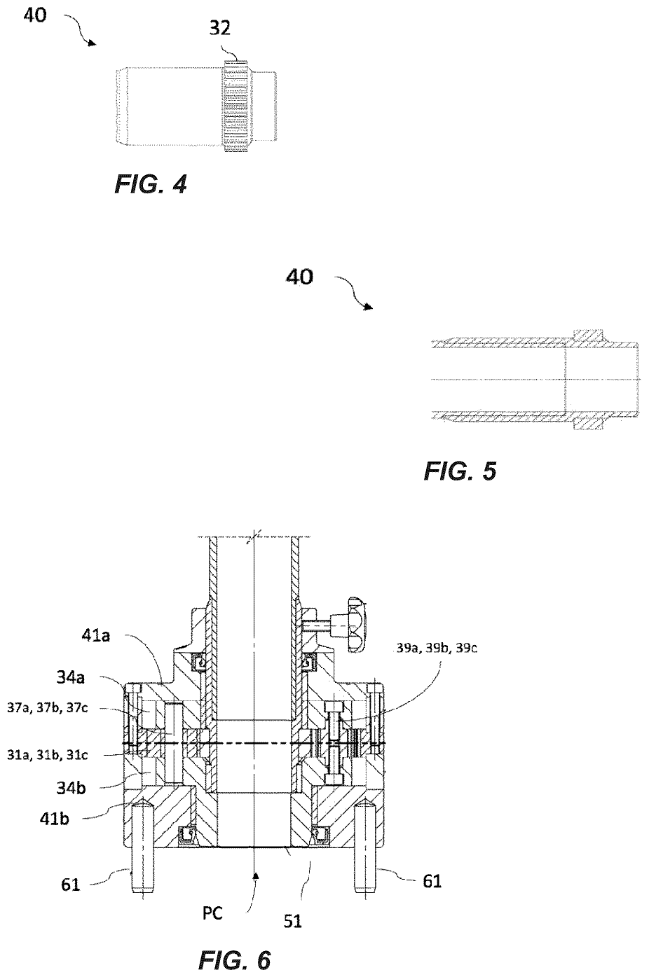

The fixed connection between the planetary gear 32 and the operating shaft 20 can be made by way of a sleeve 40 in the form of a hollow tube (FIG. 3, FIG. 4 and FIG. 5). The planetary gear 32 can be ring-shaped and fitted around the sleeve 40 (FIG. 4 and FIG. 5).

The satellite gears 31a, 31b and 31c are also held by a satellite carrier 34a, 34b (FIG. 6). In these regards, the satellite carrier is pivotably connected to the operating shaft 20 and around the elongation axis of the operating shaft 20. In particular, the satellite carrier comprises an upper plate 34a and a lower plate 34b, between which the satellite gears 31a, 31b and 31c are held in a pivoting connection. In particular, the satellite carrier comprises the upper plate 34a and the lower plate 34b in order, in the direction from the proximal end to the distal end.

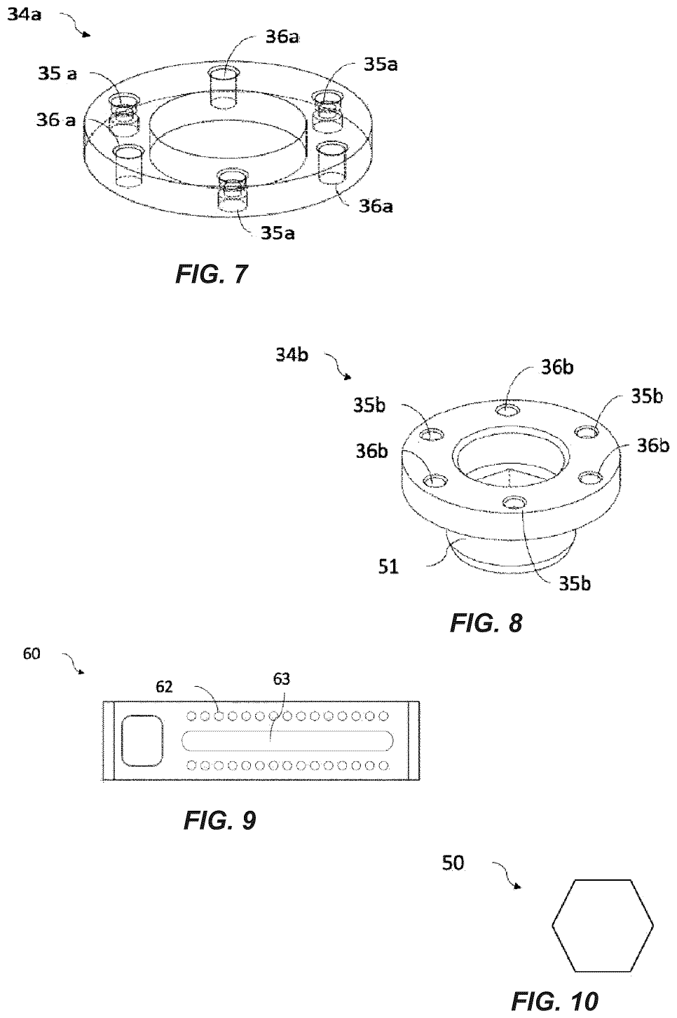

The upper plate 34a, shown in FIG. 7, is annular in shape and comprises axial upper apertures 35a and upper holding apertures 36a passing through it.

Equivalently, the lower plate 34b, shown in FIG. 8, is annular in shape and comprises axial lower apertures 35b and lower holding apertures 36b passing through it.

The upper plate 34a and the lower plate 34b are configured to face one another, with each axial upper apertures 35a corresponding to an axial lower aperture 35b, and each upper holding aperture 36a corresponding to a lower holding aperture 36b. In particular, the upper plate 34a and the lower plate 34b hold the satellite gears 31a, 31b and 31c between them. In particular, each satellite gear 31a, 31b and 31c is pivotably connected to one and the other of the upper plate 34a and the lower plate 34b.

In these regards, each satellite gear 31a, 31b and 31c is pivotably connected via a shaft, referred to as satellite shaft 37a, 37b and 37c, parallel to the operating shaft 20 (FIG. 6). Advantageously, each satellite shaft 37a, 37b and 37c engages with an axial upper aperture 35a and an axial lower aperture 35b corresponding to one another.

The upper plate 34a and the lower plate 34b are also mechanically secured to one another. In particular, this holding can involve tie rods 39a, 39b and 39c engaging with upper holding apertures 36a and lower holding apertures 36b.

Advantageously, the operating wrench 10 comprises an extension 50 (FIG. 10), of non-circular cross section, configured to be mounted in a sliding connection with the lower plate 34b so that rotation of the latter also drives the extension, in a rotational movement about the elongation axis, of the operating shaft 20. For example, the extension 50 may have a square, triangular, hexagonal, oval or citrus-shaped cross section. In particular, the cross section of the extension 50 conforms to the shape of the valve to be operated, so as to allow coupling of the valve and the free end of the extension 50.

“Citrus shape” means a shape that is generally circular and provided with indentations (or beading) in at least two sections of its periphery (such as the shape of a lemon).

Advantageously, the lower plate 34b comprises an annular ring 51 (FIG. 8) that extends from a free face of the lower plate and forms a passage, known as the central passage, which has a cross section conforming to that of the extension 50.

Also advantageously, a passage, referred to as the main passage, is provided in the epicyclic gear train and the operating shaft coaxially with the central passage CP and the direction of elongation of the operating shaft so as to allow the extension 50 to slide. According to this configuration, it is possible to adjust the projection length of the extension 50. It is understood, without needing to be specified, that the main passage aperture has a surface wherein the surface associated with the central passage aperture is circumscribed. This latter aspect thus allows the extension 50 to rotate without interacting with the planetary gear and the operating shaft.

The crown gear is also pivotably connected to the operating shaft 20. This assembly may involve the use of so-called secondary plates, respectively upper secondary plate 41a and lower secondary plate 41b, having an annular shape.

In these regards, each of the secondary plates is mechanically secured to the crown gear 33. It is understood that the crown gear is coplanar with the satellite and planetary gears.

The upper and lower plates 34a, 34b are inserted between the secondary plates.

More specifically, the upper secondary plate 41a comprises an aperture through which the operating shaft 20 passes, and is arranged against the upper plate 34a. The lower secondary plate 41b has an aperture through which an annular ring 51 passes, and is positioned against the lower plate 34b.

It is understood that positioning a secondary plate against one or the other of the upper and lower plates does not constitute a servo-control. In other words, a secondary plate can rotate in the opposite direction to the upper and lower plates.

The operating wrench 10 may also comprise embedding means configured to prevent any rotational movement of the crown gear 33 when the operating wrench 10 is engaged to operate a valve.

By way of example, the embedding means comprise an adapter plate 60 that can be embedded (FIG. 9) against an opening housing a valve, and pins 61 mechanically secured to the crown gear and configured to be embedded in apertures 62 provided in the adapter plate 60. The adapter plate 60 also comprises a main aperture 63 through which the extension can pass to enable it to be coupled with the valve.

The use of operating wrench 10 to operate a valve located at the bottom of an opening involves first positioning an adapter plate 60 on top of the opening.

The adapter plate 60 is shaped to suit the opening in question.

This is followed by the positioning of the operating wrench 10 against the adapter plate. In particular, the pins 61 are inserted into apertures 62 in the adapter plate, while the extension is coupled with the valve located at the bottom of the opening. In these regards, it may be necessary to adjust the length of the extension projecting outward from the lower plate 34b.

This step thus locks the crown gear 33 in place, preventing it from rotating when a force is exerted on the operating shaft to pivot it.

Finally, once the coupling between the extension and the valve has been achieved, a force can be exerted on the operating shaft 20 to cause it to pivot about its elongation axis; as it rotates, the operating shaft 20 drives the planetary gear 32 in the same direction and at the same speed.

By meshing, the satellite gears also pivot to describe an epicyclic movement and drive the satellite carrier, and therefore the extension, in a direction of rotation opposite that of the operating shaft 20. As it moves, the extension rotates the valve with which it is coupled.

In this way, the use of the planetary gear reduces the force required from an operator to operate a valve.

In a complementary manner, the operating wrench can comprise an indexing means configured to indicate the angular stroke of the planetary gear when the operating shaft is rotated. This last aspect enables control of the valve's operating range.

Of course, the present disclosure is not limited to the described embodiments and variant embodiments may be envisaged without departing from the scope of the invention as defined by the claims.

1. An operating wrench for a valve disposed in an opening, the operating wrench comprising:
a hollow operating shaft, which extends from a proximal end to a distal end; and
an epicyclic gear train, arranged at the distal end of the operating shaft, and configured to impose an output torque on a valve arranged in an opening when an input torque is exerted on the operating shaft, the output torque being greater than the input torque, the epicyclic gear train being of a parallel epicyclic gear train and comprising a planetary gear, a crown gear and at least one satellite gear, the at least one satellite gear being carried by a planetary carrier pivotably connected to the operating shaft, the planetary gear being connected in a fixed manner to the operating shaft and configured to mesh with the at least one satellite gear.

2. The operating wrench of claim 1, wherein a satellite carrier comprises, from the proximal end to the distal end, an upper plate and a lower plate, between which each satellite gear is pivotably mounted about a satellite shaft, the satellite shaft being parallel to the operating shaft.

3. The operating wrench of claim 2, wherein the satellite shaft is fixedly connected to each of the upper plate and the lower plate.

4. The operating wrench of claim 3, further comprising an extension having a non-circular cross section, the extension configured to be mounted in a sliding connection with the lower plate so that rotation of the lower plate drives rotational movement of the extension about a longitudinal axis of the operating shaft.

5. The operating wrench of claim 4, wherein the lower plate comprises a central passage having a cross section conforming to the cross section of the extension.

6. The operating wrench to of claim 5, further comprising a main passage in the epicyclic gear train and the operating shaft coaxial with the central passage and the the longitudinal axis of the operating shaft so as to allow the extension to slide.

7. The operating wrench of claim 6, further comprising an embedding device configured to prevent rotational movement of the crown gear when the operating wrench is engaged to operate a valve.

8. The operating wrench of claim 7, wherein the embedding device comprises an adapter plate configured to be embedded against an opening housing a valve, and pins mechanically secured to the crown gear and configured to be embedded in apertures provided in the adapter plate.

9. The operating wrench of claim 8, further comprising an indexing device configured to indicate an angular stroke of the planetary gear when the operating shaft is rotated.

10. The operating wrench of claim 9, further comprising a handle mechanically secured to the operating shaft and extending in a direction substantially perpendicular to the operating shaft.

11. The operating wrench of claim 2, further comprising an extension having a non-circular cross section, the extension configured to be mounted in a sliding connection with the lower plate so that rotation of the lower plate drives rotational movement of the extension about a longitudinal axis of the operating shaft.

12. The operating wrench of claim 11, wherein the lower plate comprises a central passage having a cross section conforming to the cross section of the extension.

13. The operating wrench of claim 12, further comprising a main passage in the epicyclic gear train and the operating shaft coaxial with the central passage and the the longitudinal axis of the operating shaft so as to allow the extension to slide.

14. The operating wrench of claim 1, further comprising an embedding device configured to prevent rotational movement of the crown gear when the operating wrench is engaged to operate a valve.

15. The operating wrench of claim 14, wherein the embedding device comprises an adapter plate configured to be embedded against an opening housing a valve, and pins mechanically secured to the crown gear and configured to be embedded in apertures provided in the adapter plate.

16. The operating wrench of claim 1, further comprising an indexing device configured to indicate an angular stroke of the planetary gear when the operating shaft is rotated.

17. The operating wrench of claim 1, further comprising a handle mechanically secured to the operating shaft and extending in a direction substantially perpendicular to the operating shaft.
